(19) United States
(12) Patent Application Publication
(10) Pub. No.: US 2019/0105933 A1
(43) Pub. Date: Apr. 11, 2019

(54) SUBLIMATION THERMAL TRANSFER SHEET AND COMBINATION OF SUBLIMATION THERMAL TRANSFER SHEET AND TRANSFER RECEIVING ARTICLE

(71) Applicant: Dai Nippon Printing Co., Ltd, Tokyo (JP)

(72) Inventors: Shinya YODA, Tokyo (JP); Emi MATSUBA, Tokyo (JP)

(73) Assignee: Dai Nippon Printing Co., Ltd., Tokyo (JP)

(21) Appl. No.: 16/089,127

(22) PCT Filed: Mar. 31, 2017
(86) PCT No.: PCT/JP2017/013758

§ 371 Date: Sep. 27, 2018

(30) Foreign Application Priority Data
Mar. 31, 2016 (JP) 2016-071744

(51) Int. Cl. B41M 5/385; B41M 5/395; B41M 5/382; C09B 53/00

(52) U.S. Cl. CPC B41M 5/385; C09B 53/00; B41M 5/38214; B41M 5/395

(57) ABSTRACT

A sublimation thermal transfer sheet and combination of a sublimation thermal transfer sheet and a transfer receiving article that meet the demand for increase in the density of a color image to be formed, that prevent decrease in the adhesiveness of a protective layer optionally formed on the color image, and that also have superior light resistance. In a sublimation thermal transfer sheet including a substrate and yellow, magenta, and cyan colorant layers provided on one surface of the substrate, the yellow and the above magenta colorant layers each contain a predetermined amount of a high-ε sublimable dye having a molar absorption coefficient of not less than 50000 and a molecular weight of not more than 650, and the cyan colorant layer contains a predetermined amount of a high-ε sublimable dye having a molar absorption coefficient of not less than 20000 and a molecular weight of not more than 420.

### TECHNICAL FIELD

The present invention relates to a sublimation thermal transfer sheet and a combination of a sublimation thermal transfer sheet and a transfer receiving article.

### BACKGROUND ART

One of known image forming methods utilizing thermal transfer is a sublimation thermal transfer method in which a sublimation thermal transfer sheet made by causing a substrate, such as a plastic film, to carry sublimable dyes is superposed on a thermal transfer image-receiving sheet made by providing a dye-receiving layer on another substrate, such as paper and a plastic film, to form a full-color image. The reproducibility and gradation of neutral tints are excellent because this method employs the sublimable dyes as colorants, and the original full-color image can be clearly reproduced on the thermal transfer image-receiving sheet. Hence, the method is applied to formation of color images generated by digital cameras, video cameras, computers and the like. The quality of the images is as high as of silver halide photography.

For example, Patent literature 1 discloses a three-color sublimation thermal transfer sheet in which a yellow dye layer, a magenta dye layer, and a cyan dye layer are layered in parallel on a substrate in this order.

### PRIOR ART LITERATURE

### Patent literature

Patent Document 1: JP HEI7-304272 A

### SUMMARY OF THE INVENTION

### Problems to be solved by the invention

Recently, a desired color image is formed on a card substrate using such a sublimation thermal transfer sheet. In this case, a protective layer for protecting the image may be formed on the color image formed on the card substrate. In addition, recently, there is a demand for improvement in quality of the color image formed on the card substrate, and it is required to increase the density of the color image to meet the demand.

To increase the density of the color image, it is required to increase the amount of dyes to be transferred from the dye layers of respective colors on the sublimation thermal transfer sheet onto the card substrate. However, if the amount of the dyes is increased, the adhesiveness of the protective layer when the protective layer is formed on the color image decreases, and detachment of flakes in the form of dots or peeling off from the edges is caused in some cases.

Such problems are remarkable when the transfer receiving article is a hard material such as a card substrate, but may also be caused when a comparatively soft material such as paper is used.

The invention of the present application has been made under these circumstances, and aims principally to provide a sublimation thermal transfer sheet and a combination of a sublimation thermal transfer sheet and a transfer receiving article that meet the demand for increase in the density of a color image to be formed and that prevent decrease in the adhesiveness of a protective layer optionally formed on the color image.

### Means for Solving the Problems

The invention of the present application for solving the above-mentioned problems is a sublimation thermal transfer sheet that comprises a substrate and yellow, magenta, and cyan colorant layers provided on one surface of the substrate, wherein the yellow colorant layer comprises at least a binder resin Y and a sublimable dye Y having a molar absorption coefficient of not less than 50000 and a molecular weight of not more than 650, wherein the magenta colorant layer comprises at least a binder resin M and a sublimable dye M having a molar absorption coefficient of not less than 50000 and a molecular weight of not more than 650, wherein the cyan colorant layer comprises at least a binder resin C and a sublimable dye C having a molar absorption coefficient of not less than 20000 and a molecular weight of not more than 650, wherein an average of a mass ratio between the binder resin Y and the sublimable dye Y (the sublimable dye Y/the binder resin Y) and a mass ratio between the binder resin M and the sublimable dye M (the sublimable dye M/the binder resin M) is not less than 0.7, and wherein a mass ratio between the binder resin C and the sublimable dye C (the sublimable dye C/the binder resin C) is not less than 0.5.

In the above invention, a sublimable dye represented by General Formula (14) below may be comprised as the sublimable dye C at a mass ratio to the binder resin C of not less than 0.5.

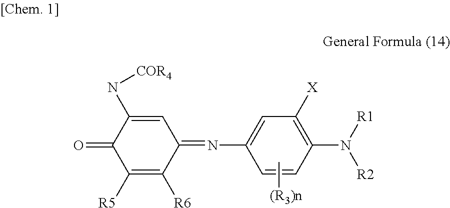

(In General Formula (14), R1 is a substituted or unsubstituted alkyl group, a cycloalkyl group, an aralkyl group, an aryl group, or represents an atom or atomic group forming a 5- or 6-membered ring together with X; R2 represents a substituted or unsubstituted alkyl group, a cycloalkyl group, an aralkyl group, or an aryl group; R1 and R2 may form a 5- or 6-membered ring optionally comprising an oxygen atom or a nitrogen atom; R₃ represents a hydrogen atom, a halogen atom, a cyano group, an optionally substituted alkyl group, a cycloalkyl group, an alkoxy group, an aralkyl group, an aryl group, an acyl group, an acylamino group, a sulfonylamino group, a ureido group, a carbamoyl group, a sulfamoyl group, or an amino group; R₄ represents a substituted or unsubstituted alkyl group, a substituted or unsubstituted cycloalkyl group, a substituted or unsubstituted aralkyl group, a substituted or unsubstituted aryl group, a substituted or unsubstituted alkoxy group, or a substituted or unsubstituted aryloxy group; R5 and R6 may be same or different and each represent a hydrogen atom, a halogen atom, a substituted or unsubstituted alkyl group, an alkoxy group, an acylamino group, a sulfonylamino group, or a ureido group; X is a hydrogen atom or represents an atom or atomic group forming a 5- or 6-membered ring together with R1; and n represents 1 or 2.)

Another invention of the present application for solving the above-mentioned problems is a combination of a sublimation thermal transfer sheet and a transfer receiving article, wherein the sublimation thermal transfer sheet is the sublimation thermal transfer sheet according to claim 1 or 2, and wherein the transfer receiving article is a card material with a deflection of not more than 35 mm determined by a bending stiffness test defined by JIS X 6305-1.

### Effect of the invention

According to the sublimation thermal transfer sheet and the combination of a sublimation thermal transfer sheet and a transfer receiving article of the present invention, it is possible to form a high-density full-color image and, when a protective layer is formed on the image, to guarantee the sufficient adhesiveness of the protective layer.

### BRIEF DESCRIPTION OF THE DRAWINGS

FIG. 1 is a schematic sectional view of an embodiment of a sublimation thermal transfer sheet of the present invention.

### EMBODIMENTS OF THE INVENTION

A sublimation thermal transfer sheet of the present invention will be described below in detail.

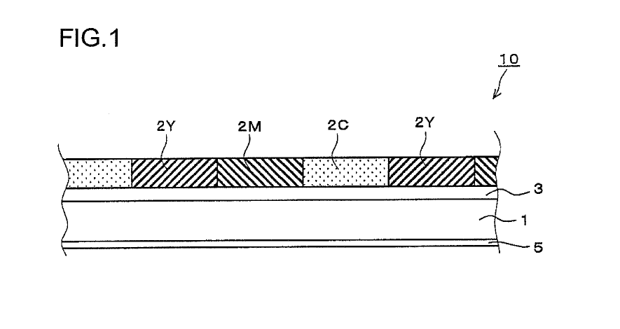

FIG. 1 is a schematic sectional view of an embodiment of the sublimation thermal transfer sheet of the present invention.

As shown in FIG. 1, in a sublimation thermal transfer sheet 10 according to the embodiment of the present invention, a yellow colorant layer 2Y, a magenta colorant layer 2M, and a cyan colorant layer 2C are provided on a substrate 1. In the sublimation thermal transfer sheet 10 according to the present embodiment shown in FIG. 1, the yellow colorant layer 2Y, the magenta colorant layer 2M, and the cyan colorant layer 2C are provided in this order from left in the drawing in parallel, but this order is not limiting. A colorant layer, such as a black colorant layer (not shown), of a color other than these three colors may be provided in addition to these three colors. In addition, the sublimation thermal transfer sheet 10 according to the present embodiment includes a primer layer 3 between the substrate 1 and the colorant layers (2Y, 2M, and 2C) of three colors and includes a back face layer 5 on a surface of the substrate 1 opposite to the surface provided with the colorant layers (2Y, 2M, and 2C), but these layers are an optional layer. Each constitution of the sublimation thermal transfer sheet 10 according to the present embodiment will be concretely described below.

### Substrate

There is no particular limitation on the substrate 1 as long as the substrate 1 has certain degrees of thermal resistance and strength, and a conventionally known material can be appropriately selected. Examples of the substrate 1 include polyethylene terephthalate films, 1,4-polycyclohexylenedimethylene terephthalate films, polyethylene naphthalate films, polyphenylene sulfide films, polystyrene films, polypropylene films, polysulfone films, aramid films, polycarbonate films, polyvinyl alcohol films, cellophane, cellulose derivatives such as cellulose acetate, polyethylene films, polyvinyl chloride films, nylon films, polyimide films, and ionomer films each having a thickness of not less than 0.5 μm and not more than 50 μm, preferably about not less than 1 μm and not more than 10μm. Furthermore, although these materials can be used solely, the materials may be combined with other materials to constitute layered structures.

The surface of the substrate 1 on which the colorant layers (2Y, 2M, and 2C) of three colors are to be formed may be subjected to adhesive treatment. The adhesive treatment can improve the adhesiveness between the substrate 1 and the colorant layers (2Y, 2M, and 2C) of three colors or between the substrate 1 and an optional layer, such as the primer layer 3, provided between the substrate 1 and the colorant layers (2Y, 2M, and 2C) of three colors.

A known resin surface modification technique such as corona discharge treatment, flame treatment, ozonization, ultraviolet treatment, radiation treatment, surface roughening, chemical treatment, plasma treatment, low temperature plasma treatment, and grafting treatment can be applied as it is as the adhesive treatment. Two or more of these treatments can be used in combination. Instead of the adhesive treatment of the substrate 1, the primer layer 3, which may be referred to as an under coat layer, may be provided between the substrate 1 and the colorant layers (2Y, 2M, and 2C) of three colors. Alternatively, the primer layer 3 may be provided between the substrate 1 that has undergone the adhesive treatment and the colorant layers (2Y, 2M, and 2C) of three colors.

### Yellow Colorant Layer

The yellow colorant layer 2Y is provided on the substrate 1 as shown in FIG. 1, and the yellow colorant layer 2Y contains at least a sublimable dye Y having a molar absorption coefficient of not less than 50000 and a molecular weight of not more than 650, and a binder resin Y. In the following description, the “sublimable dye Y having a molar absorption coefficient of not less than 50000 and a molecular weight of not more than 650” is called a “high-ε sublimable dye Y” in some cases to distinguish the dye from other sublimable dyes. Since the sublimation thermal transfer sheet according to the present embodiment contains a predetermined amount of the predetermined high-ε sublimable dye Y, it is possible to increase the density while keeping the transferring amount of a dye to a transfer receiving object small. Hence, it is possible to meet the demand for increase in the density and to guarantee the sufficient adhesiveness of the protective layer formed on the image.

### High-ε Sublimable Dye Y

There is no particular limitation on what is called the high-ε sublimable dye Y contained in the yellow colorant layer 2Y as long as the sublimable dye has a molar absorption coefficient of not less than 50000 and a molecular weight of not more than 650. Concretely, the sublimable dye can be appropriately selected from styryl sublimable dyes represented by General Formula (1) below, quinophthalone sublimable dyes represented by General Formula (2) below, pyrazolone methine sublimable dyes represented by General Formula (3) below and the like. In particular, General Formula (2) or General Formula (3) below is preferable.

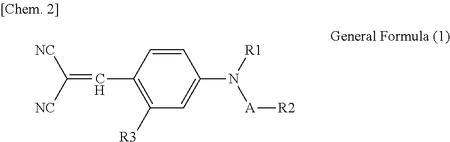

(In General Formula (1), R1 represents a substituted or unsubstituted aryl group, an allyl group, or a linear or branched alkyl group; R2 represents a linear or branched alkyl group or a substituted or unsubstituted aryl group; A represents CH₂, CH₂CH₂, CH₂CH₂O, CH₂CH₂OCH₂, or CH₂CH₂OCH₂CH₂; and R3 represents an alkyl group.)

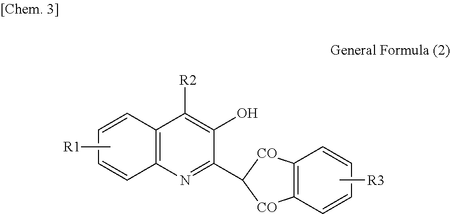

(In General Formula (2), R1 represents a hydrogen atom, an alkyl group having 1 to 8 carbon atoms, or a cycloalkyl group; R2 represents a hydrogen atom, a halogen atom, a linear or branched alkoxy group, a linear or branched alkylthio group, or a linear or branched arylthio group; and R3 represents a linear or branched alkoxycarbonyl group, a linear or branched alkylaminocarbonyl group, a linear or branched alkoxy group, a substituted or unsubstituted aryloxy group, a linear or branched alkyl group, a substituted or unsubstituted cycloalkyl group, a heterocyclic group, or a halogen atom.)

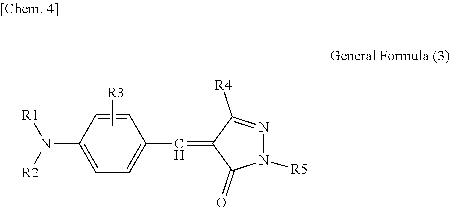

(In General Formula (3), R1 and R2 each independently represent a hydrogen atom, a linear or branched alkyl group, an allyl group, a substituted or unsubstituted aryl group, or a substituted or unsubstituted cycloalkyl group; R3 represents a hydrogen atom, a linear or branched alkyl or alkoxy group, a halogen, or an aryloxy group; R4 represents a hydrogen atom, a linear or branched alkyl group, an NR6R7 group, a linear or branched alkoxy group, a linear or branched alkoxycarbonyl group, a substituted or unsubstituted aryl group, or a C(O)NR8R9 group; and R5 represents a linear or branched alkyl group or a substituted or unsubstituted aryl group. R6, R7, R8, and R9 each independently represent a hydrogen atom, a linear or branched alkyl group, or a substituted or unsubstituted aryl group.)

The molar absorption coefficient of a sublimable dye is measured in accordance with the general rules for molecular absorptiometric analysis defined by JIS K 0115. Concretely, the sublimable dye is diluted not less than 5000 times and not more than 50000 times with ethyl acetate and measured using a commercially available visible spectrophotometer, such as UV-2600 (Shimadzu Corporation). The dilution factor is appropriately adjusted depending on the value of the molar absorption coefficient of the sublimable dye to be measured. If the sublimable dye is insoluble in ethyl acetate, the sublimable dye to be measured is dissolved in dichloromethane, trichloromethane or the like instead of ethyl acetate.

In General Formula (1) above, R1 is preferably a linear or branched alkyl group having 1 to 6 carbon atoms, further preferably a linear or branched alkyl group having 3 to 6 carbon atoms, particularly preferably a linear or branched butyl group. R2 is preferably a substituted or unsubstituted aryl group, further preferably a substituted or unsubstituted phenyl group, particularly preferably an unsubstituted phenyl group. R3 is preferably a linear or branched alkyl group having 1 to 6 carbon atoms, further preferably a linear or branched alkyl group having 1 to 3 carbon atoms, particularly preferably a methyl group. A is preferably CH₂ or CH₂CH₂, further preferably CH₂CH₂. Concrete examples of the sublimable dye Y having a molar absorption coefficient of not less than 50000 and a molecular weight of not more than 650 belonging to the styryl sublimable dyes represented by General Formula (1) above include General Formula (1-1) below.

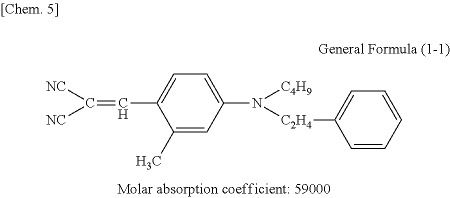

In General Formula (2) above, R1 is preferably a hydrogen atom or a linear or branched alkyl group having 1 to 6 carbon atoms, further preferably a hydrogen atom, particularly preferably an isopropyl group. R2 is preferably a hydrogen atom or a halogen atom, further preferably a hydrogen atom. R3 is preferably an alkylaminocarbonyl group represented by C(═O)—NR4R5. R4 and R5 in the alkylaminocarbonyl group are each preferably a linear or branched alkyl group having 1 td 6 carbon atoms, more preferably a linear or branched alkyl group having 3 to 6 carbon atoms. Such R3 is particularly preferably an N,N-dibutylamino group. Concrete examples of the sublimable dye Y having a molar absorption coefficient of not less than 50000 and a molecular weight of not more than 650 belonging to the quinophthalone sublimable dyes represented by General Formula (2) above include General Formulae (2-1) and (2-2) below.

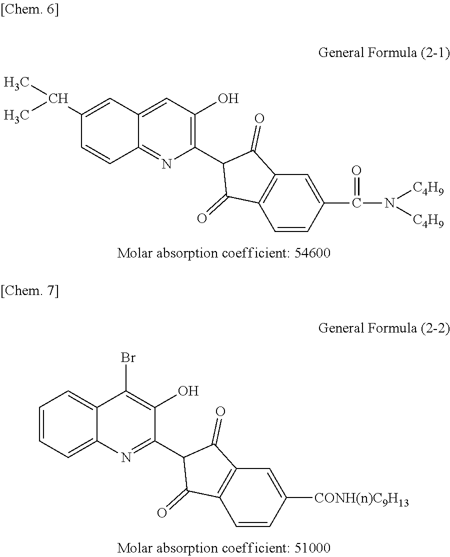

In General Formula (3) above, R1 and R2 are each preferably a linear or branched alkyl group having 1 to 6 carbon atoms, further preferably an alkyl group having 1 to 3 carbon atoms, particularly preferably an ethyl group. R3 is preferably a hydrogen atom. R4 is preferably a linear or branched alkoxy group having 1 to 6 carbon atoms, further preferably an alkoxy group having 1 to 3 carbon atoms, particularly preferably an ethoxy group. R5 is preferably a substituted or unsubstituted aryl group, further preferably a substituted or unsubstituted phenyl group, particularly preferably an unsubstituted phenyl group. Concrete examples of the sublimable dye Y having a molar absorption coefficient of not less than 50000 and a molecular weight of not more than 650 belonging to the pyrazolone methine sublimable dyes represented by General Formula (3) above include General Formula (3-1) below.

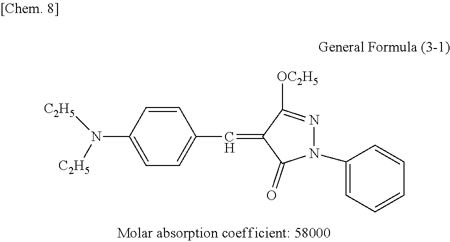

### Other Sublimable Dyes

The yellow colorant layer 2Y of the sublimation thermal transfer sheet 10 according to the present embodiment may contain a sublimable dye other than the above high-ε sublimable dye Y as a yellow sublimable dye. Examples of known yellow sublimable dyes that can be used diarylmethane dyes; triarylmethane dyes; thiazole dyes; methine dyes, such as merocyanine dyes; indoaniline dyes; azomethine dyes typified by acetophenoneazomethine, pyrazoloazomethine, imidazoleazomethine, imidazoazomethine, and pyridoneazomethine; xanthene dyes; oxazine dyes; cyanostyrene dyes typified by dicyanostyrene and tricyanostyrene; thiazine dyes; azine dyes; acridine dyes; benzeneazo dyes; azo dyes, such as pyridone azo, thiophene azo, isothiazole azo, pyrrole azo, Pillar azo, imidazole azo, thiadiazole azo, and triazole azo; spiropyran dyes; indolinospiropyran dyes; fluoran dyes; rhodaminelactam dyes; naphthoquinone dyes; anthraquinone dyes and the like.

Sublimable dyes represented by General Formula (4), General Formula (5) below and the like are particularly preferable because these dyes are available on the market.

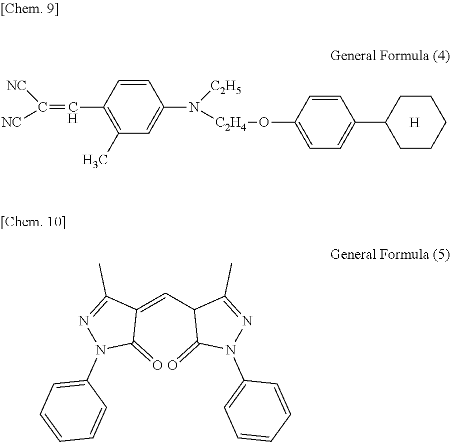

### Binder Resin Y

The yellow colorant layer 2Y of the sublimation thermal transfer sheet 10 according to the present embodiment contains the binder resin Y for carrying various sublimable dyes as described above. There is no particular limitation on the binder resin Y, and a resin having a certain degree of thermal resistance and appropriate compatibility with the sublimable dye can be used. Examples of such a binder resin include cellulosic resins, such as nitrocellulose, ethyl cellulose, hydroxyethyl cellulose, ethylhydroxycellulose, hydroxypropyl cellulose, methyl cellulose, cellulose acetate, and cellulose butyrate; vinyl resins, such as polyvinyl alcohol, polyvinyl acetate, polyvinyl butyral, polyvinyl acetoacetal, and polyvinyl pyrrolidone; acrylic resins, such as poly(meth)acrylate and poly(meth)acrylamide; polyurethane resins; polyamide resins; and polyester resins. To further enhance the thermal resistance, the above resins may be cured with a curing agent such as isocyanate curing agents, titanium chelating agents, and epoxy curing agents.

Among the binder resins exemplified above, polyvinyl butyral resins and polyvinyl acetal resins are preferable because such resins can improve the adhesiveness of the primer layer 3 optionally provided between the substrate 1 and the yellow colorant layer 2Y.

### Contents of Sublimable Dye Y and Binder Resin Y

The content of each of the high-ε sublimable dye Y and the binder resin Y described above contained in the yellow colorant layer 2Y of the sublimation thermal transfer sheet 10 according to the present embodiment is not determined considering only the yellow colorant layer 2Y but is determined considering the balance with a high-ε sublimable dye contained in the magenta colorant layer 2M. More concretely, the mass ratio between the high-ε sublimable dye Y and the binder resin Y (high-ε sublimable dye Y/binder resin Y) in the yellow colorant layer 2Y is determined so that the average of the mass ratios between the respective high-ε sublimable dyes and binder resins (high-ε sublimable dye/binder resin) in the yellow colorant layer 2Y and the magenta colorant layer 2M will be not less than 0.7, preferably not less than 0.9.

On the other hand, there is no particular limitation on the content of sublimable dyes other than the high-ε sublimable dye Y contained in the yellow colorant layer 2Y, and its design can be appropriately prepared. For example, it is preferable that the sublimable dyes other than the high-ε sublimable dye Y be contained so that the ratio of the mass of the high-ε sublimable dye Y to the total mass of sublimable dyes (high-ε sublimable dye Y/all sublimable dyes) contained in the yellow colorant layer 2Y will be not less than 0.3 and not more than 1.0, further preferably not less than 0.6 and not more than 1.0.

### Other Components

The yellow colorant layer 2Y may also contain an additive such as inorganic fine particles and organic fine particles. Examples of the inorganic fine particles include carbon black, aluminum, and molybdenum disulfide. Examples of the organic fine particles include polyethylene waxes and silicone resin fine particles.

The yellow colorant layer 2Y may also contain a release agent. Examples of conventionally known release agents, which can be used as the above release agent, include solid waxes, such as polyethylene waxes, amide waxes, and Teflon (R) powders; fluorinated surfactants and phosphoric ester surfactants; modified silicone resins; modified silicone oils; and cellulosic resins. These agents may be used singly, or as a mixture of two or more. Examples of the silicone resins include silicone-modified acrylic resins, silicone-modified butyral resins, and silicone-modified urethane resins. The modified silicone oils are classified into reactive silicone oils and non-reactive silicone oils. Examples of the reactive silicone oils include amino-modified, epoxy-modified, carboxyl-modified, carbinol-modified, methacryl-modified, mercapto-modified, and phenol-modified silicone oils; methylphenyl silicone oil; and single-end reactive and co-modified silicone oils. Examples of the non-reactive silicone oils include polyether-modified, methylstyryl-modified, alkyl-modified, higher-fatty-acid-ester-modified, specially hydrophilically modified, higher-alkoxy-modified, higher-fatty-acid-modified, and fluorine-modified silicone oils. Among cellulosic resins, alkyl cellulose resins are particularly preferable.

### Method of forming yellow colorant layer

There is no particular limitation on the method of forming the yellow colorant layer 2Y. The yellow colorant layer 2Y can be formed by dissolving or dispersing the binder resin Y, the above high-ε sublimable dye Y, and other sublimable dyes, optionally, an additive and a release agent if necessary, in an appropriate solvent to prepare a coating liquid for the colorant layer, coating the substrate 1 or the primer layer 3 described later with the coating liquid for the yellow colorant layer by a conventionally known coating device, such as gravure coater, roll coater, and wire bar coater, and drying the product. The same applies to a coating method of various coating liquids described later. The thickness of the yellow colorant layer 2Y is generally about not less than 0.2 μm and not more than 2.0 μm.

### Magenta Colorant Layer

In the sublimation thermal transfer sheet 10 according to the present embodiment, the magenta colorant layer 2M is provided on the substrate 1 as shown in FIG. 1, and the magenta colorant layer 2M also contains, similarly to the above yellow colorant layer 2Y, at least a sublimable dye M having a molar absorption coefficient of not less than 50000 and a molecular weight of not more than 650, and a binder resin M. Also in the description of the magenta colorant layer, similarly to the description of the yellow colorant layer, the “sublimable dye M having a molar absorption coefficient of not less than 50000 and a molecular weight of not more than 650” is called a “high-ε sublimable dye M” in some cases to distinguish the dye from other sublimable dyes. Since the magenta colorant layer 2M also contains a predetermined amount of the predetermined high-ε sublimable dye M, it is possible to increase the density while keeping the transferring amount of dyes to a transfer receiving object small. Hence, it is possible to meet the demand for increase in the density and to guarantee the sufficient adhesiveness of the protective layer formed on the image.

### High-ε sublimable dye

There is no particular limitation on what is called the high-ε sublimable dye M contained in the magenta colorant layer 2M as long as the sublimable dye has a molar absorption coefficient of not less than 50000 and a molecular weight of not more than 650. Concrete examples thereof include imidazole azo sublimable dyes represented by General Formula (6) below and pyrazolotriazole azomethine sublimable dyes represented by General Formula (7) below.

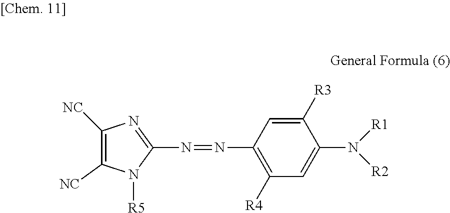

(In General Formula (6), R1 and R2 each represent an alkenyl group, an aralkyl group, or a linear or branched alkyl group; R3 represents a hydrogen atom, a methyl group, a methoxy group, or a halogen atom; R4 represents a hydrogen atom, a methyl group, a methoxy group, a formylamino group, an alkylcarbonylamino group, an alkylsulfonylamino group, or an alkoxycarbonylamino group; and R5 represents an alkyl group, an alkenyl group, an aryl group, a cyanoalkyl group, or a linear or branched alkoxycarbonylalkyl group.)

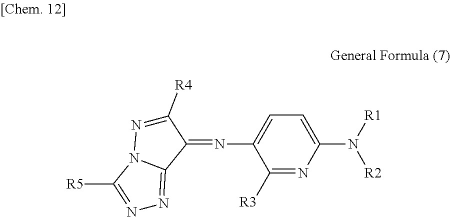

(In General Formula (7), R1 and R2 each independently represent a hydrogen atom, a linear or branched alkyl group, a vinyl group, an allyl group, a substituted or unsubstituted aryl group, an alkoxyalkyl group, an aralkyl group, an alkoxycarbonylalkyl group, a carboxyalkyl group, or an alkoxycarboxyalkyl group; and R1 and R2 may form a ring. R3 represents a hydroxy group, a halogen atom, a cyano group, a linear or branched alkyl group, an alkylformylamino group, an alkylsulfonylamino group, a formylamino group, an allylformylamino group, a sulfonylamino group, an alkylsulfonylamino group, a carbamoyl group, a sulfamoyl group, an amino group, a carboxy group, an alkoxy group, or a ureido group; and R4 and R5 each represent a hydrogen atom, a halogen atom, a cyano group, a nitro group, a linear or branched alkyl group, an allyl group, a substituted or unsubstituted aryl group, an aralkyl group, an alkoxyalkyl group, an aralkyloxyalkyl group, a thioalkyl group, an allyloxyalkyl group, an aryloxyalkyl group, a carbamoyl group, a sulfamoyl group, an oxycarbonyl group, an amino group, a formylamino group, a sulfonylamino group, an alkoxycarbonylalkyl group, a heterocyclic group, a cycloalkyl group, an alkylthio group, an alkylsulfinyl group, or an alkylsulfonyl group.)

In General Formula (6), R1 and R2 are each preferably a linear or branched alkyl group having 1 to 6 carbon atoms, further preferably a linear or branched alkyl group having 3 to 6 carbon atoms, particularly preferably a linear or branched propyl or butyl group. R3 is preferably a hydrogen atom. R4 is preferably an alkylaminocarbonyl group represented by C(═O)—NR6R7. R6 and R7 in the alkylaminocarbonyl group are each preferably a linear or branched alkyl group having 1 to 6 carbon atoms, more preferably a linear or branched alkyl group having 3 to 6 carbon atoms. Such R4 is particularly preferably an N,N-dibutylamino group. R5 is preferably a linear or branched alkyl group having 1 to 6 carbon atoms or a linear or branched allyl group having 1 to 6 carbon atoms, further preferably a linear or branched alkyl group having 3 to 6 carbon atoms or a linear or branched allyl group having 3 to 6 carbon atoms, particularly preferably a linear or branched butyl group or a propenyl group. Concrete examples of the sublimable dye M having a molar absorption coefficient of not less than 50000 and a molecular weight of not more than 650 belonging to the imidazole azo sublimable dyes represented by General Formula (6) above include General Formula (6-1) and General Formula (6-2) below.

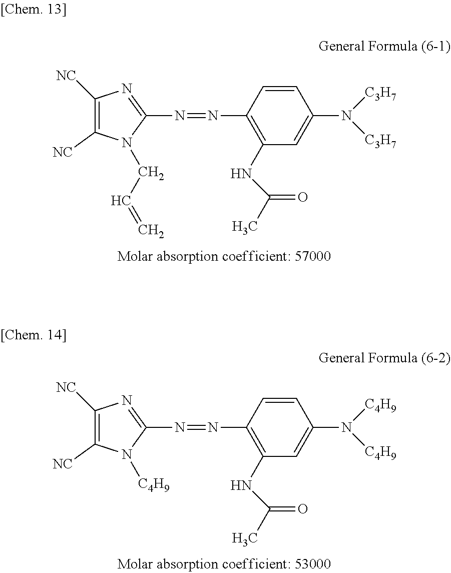

In General Formula (7) above, R1 and R2 are each preferably a linear or branched alkyl group having 1 to 6 carbon atoms, further preferably a linear alkyl group having 1 to 3 carbon atoms, particularly preferably an ethyl group. R3 is preferably a linear or branched alkyl group having 1 to 6 carbon atoms, further preferably a linear alkyl group having 1 to 3 carbon atoms, particularly preferably a methyl group. R4 is preferably a linear or branched alkyl group having 1 to 6 carbon atoms, further preferably a branched alkyl group having 3 to 6 carbon atoms, particularly preferably a tertiary butyl group. R5 is preferably a substituted or unsubstituted aryl group, further preferably a linear alkyl group having 1 to 3 carbon atoms, particularly preferably an m-toluyl group. Concrete examples of the sublimable dye M having a molar absorption coefficient of not less than 50000 and a molecular weight of not more than 650 belonging to the pyrazolotriazole azomethine sublimable dyes represented by General Formula (7) above include General Formula (7-1) below.

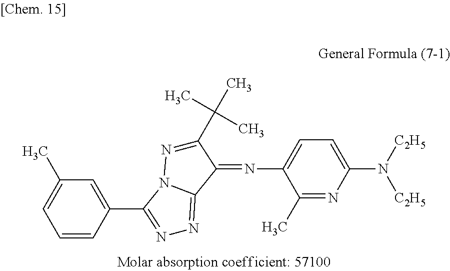

### Other Sublimable Dyes

The magenta colorant layer 2M of the sublimation thermal transfer sheet 10 according to the present embodiment may contain, similarly to the above yellow colorant layer 2Y, a sublimable dye other than the above high-ε sublimable dye M as a magenta sublimable dye. Examples thereof include various nonionic dyes such as azo dyes, anthraquinone dyes, nitro dyes, styryl dyes, naphthoquinone dyes, quinophthalone dyes, azomethine dyes, coumarin dyes, and condensed polycyclic compound dyes. In particular, sublimable dyes represented by General Formulae (8) to (13) below are preferably used in combination.

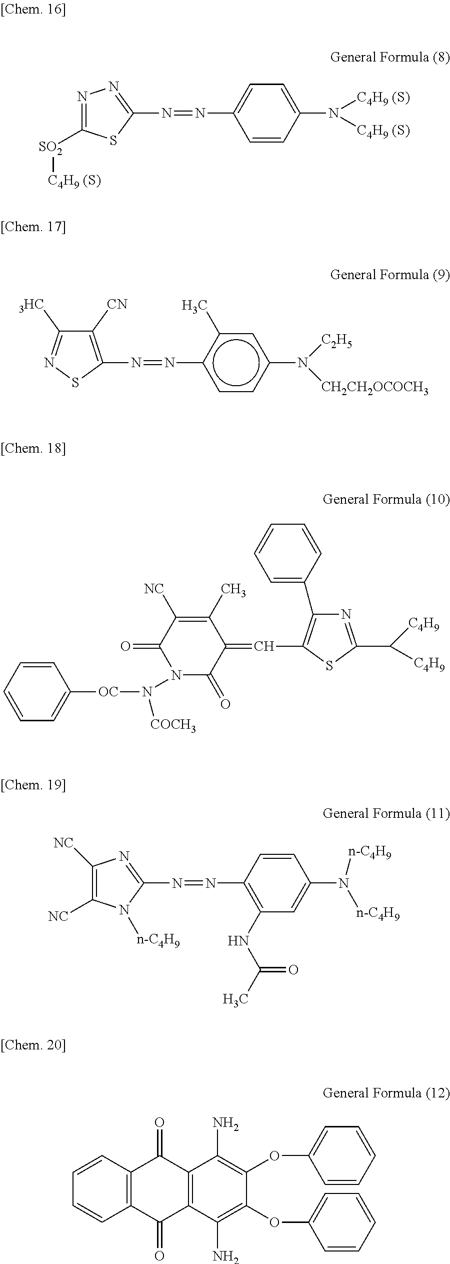

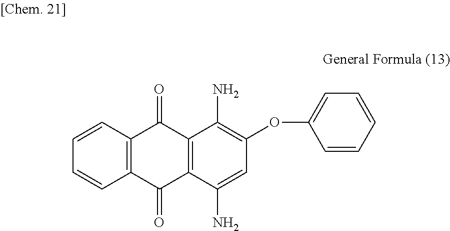

### Binder Resin M

The magenta colorant layer 2M of the sublimation thermal transfer sheet 10 according to the present embodiment contains the binder resin M for carrying various sublimable dyes as described above. There is no particular limitation on the binder resin M, and the same binder resin for the yellow colorant layer 2Y described above can be used.

### Contents of Sublimable Dye M and Binder Resin M

The content of each of the high-ε sublimable dye M and the binder resin M described above contained in the magenta colorant layer 2M of the sublimation thermal transfer sheet 10 according to the present embodiment is not determined considering only the magenta colorant layer 2M but is determined considering the balance with the high-ε sublimable dye Y contained in the yellow colorant layer 2Y described above. More concretely, similarly to the above yellow colorant layer 2Y, the mass ratio between the high-ε sublimable dye M and the binder resin M (high-ε sublimable dye M/binder resin M) in the magenta colorant layer 2M is determined so that the average of the mass ratios between the respective high-ε sublimable dyes and binder resins (high-ε sublimable dye/binder resin) in the yellow colorant layer 2Y and the magenta colorant layer 2M will be not less than 0.7, preferably not less than 0.9.

On the other hand, there is no particular limitation on the content of sublimable dyes other than the high-ε sublimable dye M contained in the magenta colorant layer 2M, and its design can be appropriately prepared. For example, it is preferable that the sublimable dyes other than the high-ε sublimable dye M be contained so that the ratio of the mass of the high-ε sublimable dye M to the total mass of sublimable dyes (high-ε sublimable dye M/all sublimable dyes) contained in the magenta colorant layer 2M will be not less than 0.2 and not more than 1.0, further preferably not less than 0.6 and not more than 1.0.

### Other Components

Similarly to the above yellow colorant layer 2Y, the magenta colorant layer 2M may also contain an additive such as inorganic fine particles and organic fine particles, as well as a release agent. Concrete examples thereof are the same as the examples described for the yellow colorant layer 2Y.

### Method of Forming Magenta Colorant Layer

There is no particular limitation on the method of forming the magenta colorant layer 2M. The same forming method as for the above yellow colorant layer 2Y can be used.

### Cyan Colorant Layer

In the sublimation thermal transfer sheet 10 according to the present embodiment, the cyan colorant layer 2C is provided on the substrate 1 as shown in FIG. 1, and the cyan colorant layer 2C contains, unlike the above yellow colorant layer 2Y and the above magenta colorant layer 2M, at least a sublimable dye C having a molar absorption coefficient of not less than 20000 and a molecular weight of not more than 650, and a binder resin C. Also in the description of the cyan colorant layer, similarly to the descriptions of the yellow colorant layer and the magenta colorant layer, the “sublimable dye C having a molar absorption coefficient of not less than 20000 and a molecular weight of not more than 650” is called a “high-ε sublimable dye C” in some cases to distinguish the dye from other sublimable dyes. Since a predetermined amount of what is called the high-ε sublimable dye C with such a molar absorption coefficient and molecular weight is contained, it is possible to increase the density while keeping the transferring amount of dyes to a transfer receiving object small. Hence, it is possible to meet the demand for increase in the density and to guarantee the sufficient adhesiveness of the protective layer formed on the image.

### High-ε Sublimable Dye C

There is no particular limitation on what is called the high-ε sublimable dye C contained in the cyan colorant layer 2C as long as the sublimable dye has a molar absorption coefficient of not less than 20000 and a molecular weight of not more than 650. Concretely, it is preferable to use an indoaniline sublimable dyes represented by General Formula (14) below. Using the indoaniline sublimable dyes can improve the light resistance in addition to the density and the adhesiveness of the protective layer.

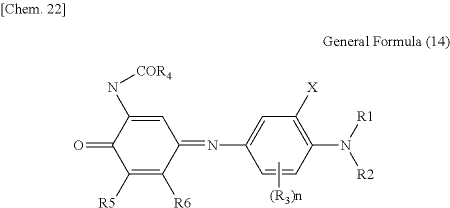

(In General Formula (14), R1 is a linear or branched alkyl group, a cycloalkyl group, an aralkyl group, an aryl group, or represents an atom or atomic group forming a 5- or 6-membered ring together with X; R2 represents a linear or branched alkyl group, a cycloalkyl group, an aralkyl group, or an aryl group; R1 and R2 may form a 5-or 6-membered ring optionally containing an oxygen atom or a nitrogen atom; R3 represents a hydrogen atom, a halogen atom, a cyano group, a linear or branched alkyl group, a cycloalkyl group, an alkoxy group, an aralkyl group, an aryl group, an acyl group, an acylamino group, a sulfonylamino group, a ureido group, a carbamoyl group, a sulfamoyl group, or an amino group; R4 represents a linear or branched alkyl group, a substituted or unsubstituted cycloalkyl group, a linear or branched aralkyl group, a substituted or unsubstituted aryl group, a linear or branched alkoxy group, or a substituted or unsubstituted aryloxy group; R5 and R6 may be the same or different and each represent a hydrogen atom, a halogen atom, a linear or branched alkyl group, an alkoxy group, an acylamino group, a sulfonylamino group, or a ureido group; X is a hydrogen atom or represents an atom or atomic group forming a 5- or 6-membered ring together with R1; and n represents 1 or 2.)

In General Formula (14) above, R1 and R2 are each preferably a linear or branched alkyl group having 1 to 6 carbon atoms, further preferably a linear alkyl group having 1 to 3 carbon atoms, particularly preferably an ethyl group. R3 is preferably a linear or branched alkyl group having 1 to 6 carbon atoms, further preferably a linear alkyl group having 1 to 3 carbon atoms, particularly preferably a methyl group. R4 is preferably a linear or branched alkyl group having 1 to 6 carbon atoms, further preferably a linear alkyl group having 1 to 3 carbon atoms or a phenyl group, particularly preferably a methyl group. R5 is preferably a halogen atom, further preferably a chlorine atom. R6 is preferably a hydrogen atom or a linear or branched alkyl group having 1 to 6 carbon atoms, further preferably a hydrogen atom or a linear alkyl group having 1 to 3 carbon atoms, particularly preferably a methyl group. Concrete examples of the sublimable dye C having a molar absorption coefficient of not less than 20000 and a molecular weight of not more than 650 belonging to the indoaniline sublimable dyes represented by General Formula (14) above include General Formulae (14-1) to (14-5) below.

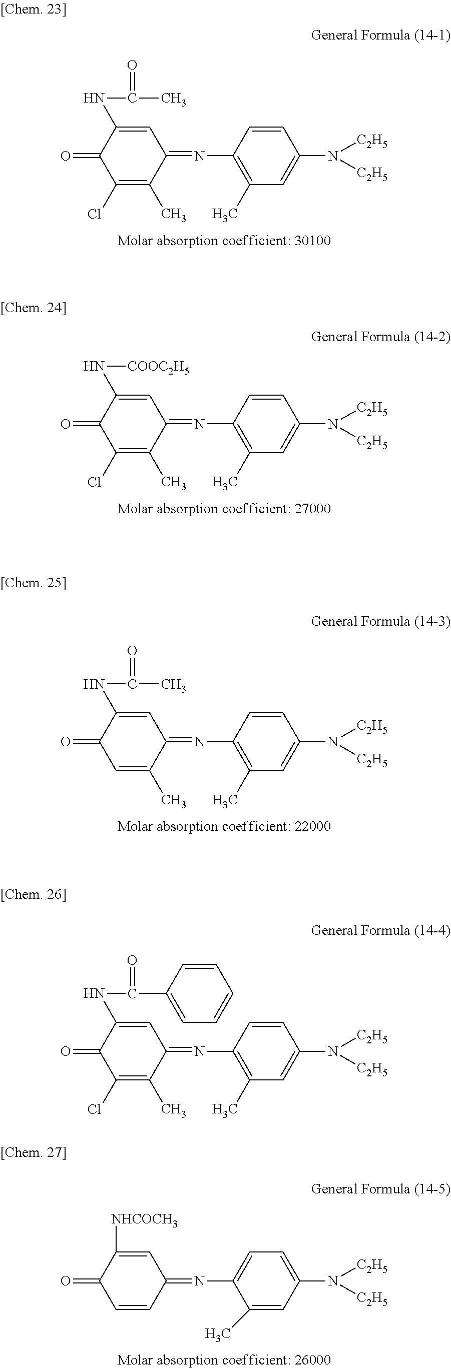

Examples of what is called the high-ε sublimable dye C other than the above indoaniline sublimable dyes include sublimable dyes represented by General Formula (15) and General Formula (16) below.

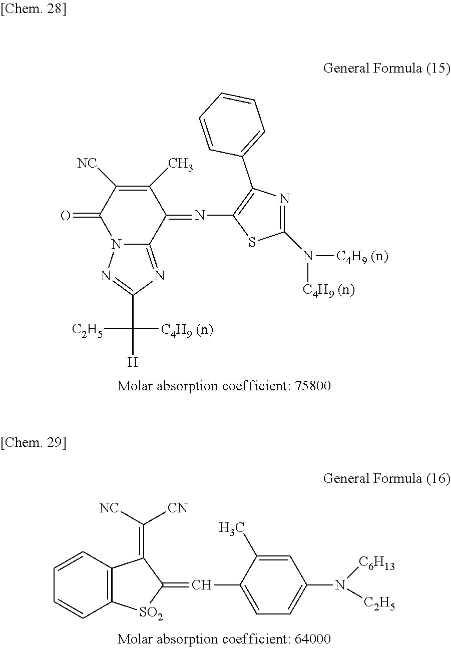

### Other Sublimable Dyes

The cyan colorant layer 2C of the sublimation thermal transfer sheet 10 according to the present embodiment may contain, similarly to the above yellow colorant layer 2Y and the magenta colorant layer 2M, a sublimable dye other than the above high-ε sublimable dye C as a cyan sublimable dye. It is preferable that an anthraquinone sublimable dyes represented by General Formula (17) below be contained. Using the anthraquinone sublimable dyes in combination with the above high-ε sublimable dye C further can improve the light resistance.

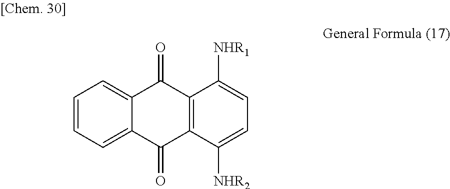

(In General Formula (17), R1 and R2 each represent a linear or branched alkyl group, a substituted or unsubstituted cycloalkyl group, a substituted or unsubstituted aryl group, a substituted or unsubstituted heterocyclic group, an allyl group, or a substituted or unsubstituted aralkyl group.)

Concrete examples of the anthraquinone sublimable dyes represented by General Formula (17) above include General Formulae (17-1) to (17-3) below.

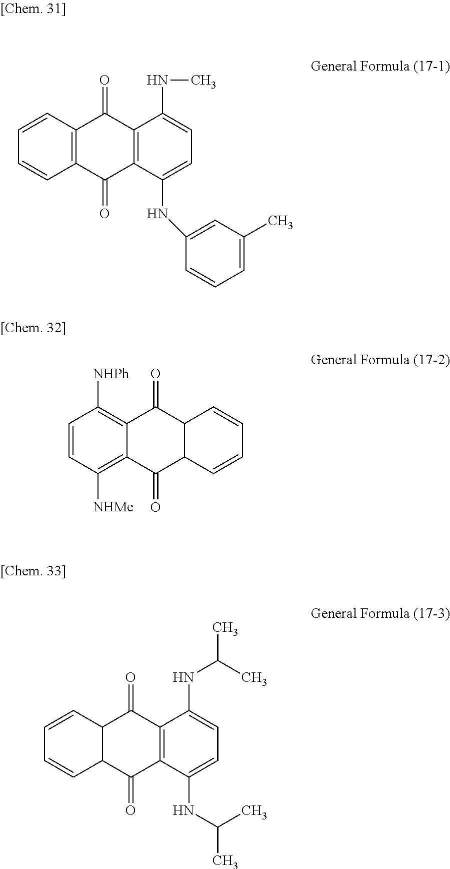

### Binder Resin C

The cyan colorant layer 2C of the sublimation thermal transfer sheet 10 according to the present embodiment contains the binder resin C for carrying various sublimable dyes as described above. There is no particular limitation on the binder resin C, and the same binder resin for the yellow colorant layer 2Y or the magenta colorant layer 2M described above can be used.

### Contents of Sublimable Dye C and Binder Resin C

The content of each of the high-ε sublimable dye C and the binder resin C described above contained in the cyan colorant layer 2C of the sublimation thermal transfer sheet 10 according to the present embodiment is determined so that the mass ratio between the high-ε sublimable dye C and the binder resin C (high-ε sublimable dye C/binder resin C) will be not less than 0.5. In particular, it is preferable that the sublimable dye represented by General Formula (14) above be contained at a mass ratio to the binder resin C of not less than 0.5.

On the other hand, there is no particular limitation on the content of sublimable dyes other than the high-ε sublimable dye C contained in the cyan colorant layer 2C, and its design can be appropriately prepared. For example, it is preferable that the sublimable dyes other than the high-ε sublimable dye C be contained so that the ratio of the mass of the high-ε sublimable dye C to the total mass of sublimable dyes (high-ε sublimable dye C/all sublimable dyes) contained in the cyan colorant layer 2C will be not less than 0.2 and not more than 1.0, further preferably not less than 0.6 and not more than 1.0.

### Other Components

Similarly to the above yellow colorant layer 2Y and the above magenta colorant layer 2M, the cyan colorant layer 2C may also contain an additive such as inorganic fine particles and organic fine particles, as well as a release agent. Concrete examples thereof are the same as the examples described for the yellow colorant layer 2Y.

### Method of Forming Cyan Colorant Layer

There is no particular limitation on the method of forming the cyan colorant layer 2C. The same forming method as for the above yellow colorant layer 2Y or the above magenta colorant layer 2M can be used.

### Primer Layer

As shown in FIG. 1, in the sublimation thermal transfer sheet 10 according to the present embodiment, the primer layer 3 is provided between the substrate 1 and the colorant layers (2Y, 2M, and 2C) of three colors. The primer layer 3 is an optional layer, but this layer can improve the adhesiveness between the substrate 1 and the colorant layers (2Y, 2M, and 2C) of three colors.

Examples of a resin constituting the primer layer 3 include polyester resins, polyvinyl pyrrolidone resins, polyvinyl alcohol resins, hydroxyethyl cellulose, polyacrylic ester resins, polyvinyl acetate resins, polyurethane resins, styrene acrylate resins, polyacrylamide resins, polyamide resins, polyether resins, polystyrene resins, polyethylene resins, polypropylene resins, polyvinyl chloride resins, and polyvinyl acetal resins such as polyvinyl acetoacetal and polyvinyl butyral.

The primer layer 3 may contain inorganic fine particles. This constitution can, not only prevents irregular transfer of the colorant layers (2Y, 2M, and 2C) of three colors to the thermal transfer image-receiving sheet at the time of thermal transfer but also prevents transfer of the dyes from the colorant layers (2Y, 2M, and 2C) of three colors to the primer layer 3 on printing. Hence, the dyes can be effectively diffused into the receiving layer of the thermal transfer image-receiving sheet, and the printing density can be enhanced.

There is no particular limitation on the inorganic fine particles contained in the primer layer 3. Examples thereof include fine particles of alumina, silica, carbon black, molybdenum disulfide and the like. These inorganic fine particles may be derived from colloidal inorganic fine particles. Examples of the colloidal inorganic fine particles include silica sols, colloidal silica, alumina or hydrates of alumina (such as colloidal alumina, cationic aluminum oxide or its hydrates, and pseudo-boehmite), aluminum silicate, magnesium silicate, magnesium carbonate, magnesium oxide, and titanium oxide. Such colloidal inorganic fine particles may be formed into an acidic type, may become positively (+) charged, or may be surface-treated in order to facilitate dispersion into a solvent or a dispersion medium in the form of a sol.

There is no particular limitation on the shape of the inorganic fine particles contained in the primer layer 3. Any shapes including spherical, acicular, plate-shaped, feathery, and amorphous shapes are possible. There is no particular limitation on the particle size of the inorganic fine particles. However, the transparency of the primer layer 3 tends to decrease if the primer layer 3 contains mainly inorganic fine particles having a primary particle size of more than 100 nm. Considering this point, the primer layer 3 preferably contains mainly inorganic fine particles having a primary particle size of not more than 100 nm, more preferably not more than 50 nm, particularly preferably not less than 3 nm and not more than 30 nm. The primary particle size may be measured by visual measurement using a scanning electron microscope (SEM), a transmission electron microscope (TEM) or the like, or by mechanical instrumentation using a particle size distribution analyzer utilizing dynamic light scattering, static light scattering or the like. The term “mainly” means not less than 50% by mass of the total mass of the inorganic fine particles contained in the primer layer 3. There is no particular limitation on its lower limit value, but the value is about 0.1 μm in terms of the primary particle size.

The primer layer 3 can be formed by dissolving or dispersing the resin and inorganic fine particles exemplified above in a suitable solvent to prepare a coating liquid for the primer layer, coating one surface of the substrate 1 with this coating liquid by a conventionally known coating device, and drying the product. There is no particular limitation on the coating amount of the coating liquid for the primer layer, but the coating amount is preferably such that the thickness of the primer layer after drying is not less than 0.02 μm and not more than 1.0 μm.

Various functional layers may be provided together with or instead of the primer layer 3. Examples of the various functional layers include an antistatic layer.

### Back Face Layer

As shown in FIG. 1, the back face layer 5 is provided on the surface of the substrate 1 opposite to the surface provided with the colorant layers (2Y, 2M, and 2C) of three colors. Similarly to the primer layer 3, the back face layer 5 is also an optional layer. However, providing the back face layer 5 can improve the thermal resistance and gives the driving stability to a thermal head on printing, etc.

A resin to be used to form the back face layer 5 may be appropriately selected from conventionally known thermoplastic resins and the like. Examples of such a thermoplastic resin include thermoplastic resins including polyester resins, polyacrylic ester resins, polyvinyl acetate resins, styrene acrylate resins, polyurethane resins, polyolefin resins such as polyethylene resins and polypropylene resins, polystyrene resins, polyvinyl chloride resins, polyether resins, polyamide resins, polyimide resins, polyamide imide resins, polycarbonate resins, polyacrylamide resins, polyvinyl chloride resins, polyvinyl butyral resins, polyvinyl acetal resins such as polyvinyl acetoacetal resins; and silicone modified form thereof.

A curing agent may be added to the above resin. There is no particular limitation on polyisocyanate resins that function as curing agents, and conventionally known resins can be used. Among these resins, use of adducts of aromatic isocyanates is desirable. Examples of the aromatic polyisocyanates include 2,4-toluene diisocyanate, 2,6-toluene diisocyanate, mixtures of 2,4-toluene diisocyanate and 2,6-toluene diisocyanate, 1,5-naphthalene diisocyanate, tolidine diisocyanate, p-phenylene diisocyanate, trans-cyclohexane-1,4-diisocyanate, xylylene diisocyanate, triphenylmethane triisocyanate, and tris(isocyanatophenyl)thiophosphate. In particular, 2,4-toluene diisocyanate, 2,6-toluene diisocyanate, or a mixture of 2,4-toluene diisocyanate and 2,6-toluene diisocyanate is preferable. Such polyisocyanate resins can cross-link the above hydroxy-group-containing thermoplastic resin by utilizing its hydroxy groups, thereby improving the coating strength and thermal resistance of the back face layer.

Further, the back face layer 5 preferably contains, in addition to the above thermoplastic resin, various additives for improving its slipping property, such as release agents including waxes, higher fatty acid amides, phosphoric ester compounds, metal soaps, silicone oils, and surfactants; organic powder including fluorine-containing resins; and inorganic particles including silica, clay, talc, and calcium carbonate, particularly preferably at least one of phosphoric esters and metal soaps.

For example, the back face layer 5 can be formed by dispersing or dissolving the above thermoplastic resin and various additives, which are optionally added as required, in a suitable solvent to prepare a coating liquid for the back face layer, coating a surface of the substrate 1 opposite to the side provided with the colorant layers with this coating liquid by a conventionally known coating device, and drying the product. There is no particular limitation on the coating amount of the coating liquid for the back face layer, but the coating amount is preferably such that the thickness of the back face layer after drying is not more than 3 μm, more preferably not less than 0.1 μm and not more than 2 μm.

### Transfer Receiving Article

There is no particular limitation on the transfer receiving article, which is the counterpart of the sublimation thermal transfer sheet according to the present embodiment described above. Examples thereof include various transfer receiving articles such as a thermal transfer image-receiving sheet, an intermediate transfer medium, and furthermore, what is called a card material, etc. each provided with a receiving layer. The sublimation thermal transfer sheet according to the present embodiment can be suitably applied to a card material with a deflection of not more than 35 mm determined by the bending stiffness test defined by JIS X 6305-1 among the above articles. Since such a card material is hard, thermal transfer is generally difficult, and desired colors cannot be reproduced by thermal transfer in some cases. However, since the colorant layers of the respective colors of the sublimation thermal transfer sheet according to the present embodiment contain predetermined amounts of what are called the high-ε sublimable dyes, a desired image can be formed on such a hard card.

### EXAMPLES

The embodiment of the present invention will be described below with examples and comparative examples. Unless otherwise specified, the term “part(s)” in the sentences is based on mass.

### Example 1

A polyethylene terephthalate film having a thickness of 5 μm was used as a substrate. This substrate was coated with a coating liquid for a back face layer with the composition below so that the thickness after drying would be 1.0 μm to form a back face layer. Then, the surface of the substrate opposite to the side provided with the back face layer was coated with a coating liquid for a primer layer with the composition below so that the thickness after drying would be 0.10 μm to form a primer layer. Then, a coating liquid Y1 for a yellow colorant layer, a coating liquid M1 for a magenta colorant layer, and a coating liquid C1 for a cyan colorant layer with the composition below were applied over the primer layer so as to be layered in parallel so that the thickness after drying would be 0.35 μm, and the product was dried (at 80° C. for 2 minutes). A yellow colorant layer, a magenta colorant layer, and a cyan colorant layer were thus formed, so that a sublimation thermal transfer sheet of Example 1 was obtained.

### <Coating Liquid for Back Face Layer>

| | | |
|---|---|---|
| Polyvinyl acetal resin (hydroxyl value: 12% by mass) | 36 | parts |
| (S-LEC (R) KS-1, manufactured by Sekisui Chemical | | |
| Co., Ltd.) | | |
| Polyisocyanate (NCO = 17.3% by mass) | 25 | parts |
| (BURNOCK (R) D750, manufactured by DIC Corporation) | | |
| Silicone resin fine particles (particle size: 4 μm, | 1 | part |
| polygonal) | | |
| (Tospearl 240, manufactured by Momentive Performance | | |
| Materials Japan LLC) | | |
| Zinc stearyl phosphate | 10 | parts |
| (LBT-1830 purified, manufactured by Sakai Chemical | | |
| Industry Co., Ltd.) | | |
| Zinc stearate | 10 | parts |
| (SZ-PF, manufactured by Sakai Chemical Industry Co., | | |
| Ltd.) | | |
| Polyethylene wax | 3 | parts |
| (Polywax 3000, manufactured by Toyo ADL Corporation) | | |
| Ethoxylated alcohol-modified wax | 7 | parts |
| (UNITOX 750, manufactured by Toyo ADL Corporation) | | |
| Methyl ethyl ketone | 200 | parts |
| Toluene | 100 | parts |

### <Coating Liquid for Primer Layer>

| | | |
|---|---|---|
| PVP resin (solid content: 100%) | 1.5 | parts |
| (K-90, manufactured by ISP Japan Ltd.) | | |
| Alumina sol (solid content: 10%) | 35.0 | parts |
| Water | 30 | parts |
| Isopropyl alcohol (IPA) | 33.5 | parts |

### <Coating Liquid Y1 for Yellow Colorant Layer>

| | | |
|---|---|---|
| As a high-ε sublimable dye, the compound represented by | 5.7 | parts |
| General Formula (2-1) above | | |
| Polyvinyl acetoacetal resin | 3.5 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### <Coating Liquid M1 for Magenta Colorant Layer>

| | | |
|---|---|---|
| As a high-ε sublimable dye, the compound represented by | 2.08 | parts |
| General Formula (7-1) above | | |
| As another sublimable dye, the compound represented by | 2.72 | parts |
| General Formula (12) above | | |
| As another sublimable dye, the compound represented by | 1.84 | parts |
| General Formula (13) above | | |
| Polyvinyl acetoacetal resin | 3.5 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### <Coating Liquid C1 For Cyan Colorant Layer>

| | | |
|---|---|---|
| As a high-ε sublimable dye, the compound represented by | 2.56 | parts |
| General Formula (14-1) above | | |
| As a high-ε sublimable dye, the compound represented by | 1.28 | parts |
| General Formula (15) above | | |
| As another sublimable dye, the compound represented by | 2.56 | parts |
| General Formula (17-1) above | | |
| Polyvinyl acetoacetal resin | 3.5 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### Example 2

A sublimation thermal transfer sheet of Example 2 was obtained under entirely the same conditions as for Example 1 except that a coating liquid Y2 for a yellow colorant layer with the composition below was used as the coating liquid for a yellow colorant layer, that a coating liquid M2 for a magenta colorant layer with the composition below was used as the coating liquid for a magenta colorant layer, and that a coating liquid C2 for a cyan colorant layer with the composition below was used as the coating liquid for a cyan colorant layer.

### <Coating Liquid Y2 for Yellow Colorant Layer>

| | | |
|---|---|---|
| As a high-ε sublimable dye, the compound represented by | 5.7 | parts |
| General Formula (2-1) above | | |
| Polyvinyl acetoacetal resin | 4.2 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### <Coating Liquid M2 for Magenta Colorant Layer>

| | | |
|---|---|---|
| As a high-ε sublimable dye, the compound represented by | 2.08 | parts |
| General Formula (7-1) above | | |
| As another sublimable dye, the compound represented by | 2.72 | parts |
| General Formula (12) above | | |
| As another sublimable dye, the compound represented by | 1.84 | parts |
| General Formula (13) above | | |
| Polyvinyl acetoacetal resin | 4.2 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### <Coating Liquid C2 for Cyan Colorant Layer>

| | | |
|---|---|---|
| As a high-ε sublimable dye, the compound represented by | 2.56 | parts |
| General Formula (14-1) above | | |
| As a high-ε sublimable dye, the compound represented by | 1.28 | parts |
| General Formula (15) above | | |
| As another sublimable dye, the compound represented by | 2.56 | parts |
| General Formula (17-1) above | | |
| Polyvinyl acetoacetal resin | 4.2 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### Example 3

A sublimation thermal transfer sheet of Example 3 was obtained under entirely the same conditions as for Example 1 except that a coating liquid M3 for a magenta colorant layer with the composition below was used as the coating liquid for a magenta colorant layer and that a coating liquid C3 for a cyan colorant layer with the composition below was used as the coating liquid for a cyan colorant layer.

### <Coating Liquid M3 for Magenta Colorant Layer>

| | | |
|---|---|---|
| As a high-ε sublimable dye, the compound represented by | 1.15 | parts |
| General Formula (7-1) above | | |
| As another sublimable dye, the compound represented by | 2.72 | parts |
| General Formula (12) above | | |
| As another sublimable dye, the compound represented by | 1.84 | parts |
| General Formula (13) above | | |
| Polyvinyl acetoacetal resin | 3.5 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### <Coating Liquid C3 for Cyan Colorant Layer>

| | | |
|---|---|---|
| As a high-ε sublimable dye, the compound represented by | 3.0 | parts |
| General Formula (14-1) above | | |
| As another sublimable dye, the compound represented by | 3.5 | parts |
| General Formula (17-1) above | | |
| Polyvinyl acetoacetal resin | 3.5 | parts |
| (S-LEC (R) KS-5, manufactured by Sekisui Chemical | | |
| Co., Ltd.) | | |
| Polyolefin wax | 0.2 | parts |
| Modified silicone oil | 0.15 | parts |
| (X-22-3939, manufactured by Shin-Etsu Chemical Co., | | |
| Ltd.) | | |
| Neoethanol | 4.2 | parts |
| Toluene | 42.1 | parts |
| Methyl ethyl ketone | 42.1 | parts |

### Example 4

A sublimation thermal transfer sheet of Example 4 was obtained under entirely the same conditions as for Example 1 except that a coating liquid Y4 for a yellow colorant layer with the composition below was used as the coating liquid for a yellow colorant layer, that a coating liquid M4 for a magenta colorant layer with the composition below was used as the coating liquid for a magenta colorant layer, and that a coating liquid C4 for a cyan colorant layer with the composition below was used as the coating liquid for a cyan colorant layer.

### <Coating Liquid Y4 for Yellow Colorant Layer>

| | |
|---|---|
| As a high-ε sublimable dye, the compound | 5.7 parts |
| represented by General Formula (2-1) above | |
| Polyvinyl acetoacetal resin | 4.55 parts |
| (S-LEC (R) KS-5, manufactured by Sekisui | |
| Chemical Co., Ltd.) | |
| Polyolefin wax | 0.2 parts |
| Modified silicone oil | 0.15 parts |
| (X-22-3939, manufactured by Shin-Etsu | |
| Chemical Co., Ltd.) | |
| Neoethanol | 4.2 parts |
| Toluene | 42.1 parts |
| Methyl ethyl ketone | 42.1 parts |

### <Coating Liquid M4 for Magenta Colorant Layer>

| | |
|---|---|
| As a high-ε sublimable dye, the compound represented | 1.15 parts |
| by General Formula (7-1) above | |
| As another sublimable dye, the compound represented | 2.72 parts |
| by General Formula (12) above | |
| As another sublimable dye, the compound represented | 1.84 parts |
| by General Formula (13) above | |
| Polyvinyl acetoacetal resin | 4.55 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### <Coating Liquid C4 for Cyan Colorant Layer>

| | |
|---|---|
| As a high-ε sublimable dye, the compound represented | 3.0 parts |
| by General Formula (14-1) above | |
| As another sublimable dye, the compound represented | 3.5 parts |
| by General Formula (17-1) above | |
| Polyvinyl acetoacetal resin | 4.55 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### Example 5

A sublimation thermal transfer sheet of Example 5 was obtained under entirely the same conditions as for Example 1 except that a coating liquid Y5 for a yellow colorant layer with the composition below was used as the coating liquid for a yellow colorant layer and that a coating liquid C5 for a cyan colorant layer with the composition below was used as the coating liquid for a cyan colorant layer.

### <Coating Liquid Y5 for Yellow Colorant Layer>

| | |
|---|---|
| As a high-ε sublimable dye, the compound represented by | 3.36 parts |
| General Formula (2-1) above | |
| As another sublimable dye, the compound represented by | 2.24 parts |
| General Formula (5) above | |
| Polyvinyl acetoacetal resin | 3.5 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical Co., | |
| Ltd.) | |
| Neoethanol | 4.2 parts |
| Toluene | 42.1 parts |
| Methyl ethyl ketone | 42.1 parts |

### <Coating Liquid C5 for Cyan Colorant Layer>

| | |
|---|---|
| As a high-ε sublimable dye, the compound represented | 2.31 parts |
| by General Formula (14-1) above | |
| As a high-ε sublimable dye, the compound represented | 1.155 parts |
| by General Formula (16) above | |
| As another sublimable dye, the compound represented | 2.31 parts |
| by General Formula (17-1) above | |
| Polyvinyl acetoacetal resin | 3.5 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### Example 6

A sublimation thermal transfer sheet of Example 6 was obtained under entirely the same conditions as for Example 1 except that a coating liquid Y6 for a yellow colorant layer with the composition below was used as the coating liquid for a yellow colorant layer and that the coating liquid C3 for a cyan colorant layer with the composition above was used as the coating liquid for a cyan colorant layer.

### <Coating Liquid Y6 for Yellow Colorant Layer>

| | |
|---|---|
| As a high-ε sublimable dye, the compound represented | 5.7 parts |
| by General Formula (3-1) above | |
| Polyvinyl acetoacetal resin | 3.5 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured byShin-Etsu Chemical Co., | |
| Ltd.) | |
| Neoethanol | 4.2 parts |
| Toluene | 42.1 parts |
| Methyl ethyl ketone | 42.1 parts |

### Example 7

A sublimation thermal transfer sheet of Example 7 was obtained under entirely the same conditions as for Example 1 except that a coating liquid Y7 for a yellow colorant layer with the composition below was used as the coating liquid for a yellow colorant layer, that a coating liquid M7 for a magenta colorant layer with the composition below was used as the coating liquid for a magenta colorant layer, and that a coating liquid C7 for a cyan colorant layer with the composition below was used as the coating liquid for a cyan colorant layer.

### <Coating Liquid Y7 for Yellow Colorant Layer>

| | |
|---|---|
| As a high-ε sublimable dye, the compound represented | 2.5 parts |
| by General Formula (2-1) above | |
| As another sublimable dye, the compound represented | 2.0 parts |
| by General Formula (5) above | |
| Polyvinyl acetoacetal resin | 3.0 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### <Coating Liquid M7 for Magenta Colorant Layer>

| | |
|---|---|
| As a high-ε sublimable dye, the compound represented | 1.9 parts |
| by General Formula (7-1) above | |
| As another sublimable dye, the compound represented | 1.9 parts |
| by General Formula (12) above | |
| As another sublimable dye, the compound represented | 1.9 parts |
| by General Formula (13) above | |
| Polyvinyl acetoacetal resin | 3.0 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### <Coating Liquid C7 for Cyan Colorant Layer>

| | |
|---|---|
| As a high-ε sublimable dye, the compound represented | 1.1 parts |
| by General Formula (14-1) above | |
| As a high-ε sublimable dye, the compound represented | 1.5 parts |
| by General Formula (16) above | |
| As another sublimable dye, the compound represented | 1.5 parts |
| by General Formula (17-1) above | |
| Polyvinyl acetoacetal resin | 3.0 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### Comparative Example 1

A sublimation thermal transfer sheet of Comparative Example 1 was obtained under entirely the same conditions as for Example 1 except that a coating liquid Y11 for a yellow colorant layer with the composition below was used as the coating liquid for a yellow colorant layer, that a coating liquid M11 for a magenta colorant layer with the composition below was used as the coating liquid for a magenta colorant layer, and that a coating liquid C11 for a cyan colorant layer with the composition below was used as the coating liquid for a cyan colorant layer.

### <Coating Liquid Y11 for Yellow Colorant Layer>

| | |
|---|---|
| As a sublimable dye, the compound represented | 7.0 parts |
| by General Formula (5) above | |
| Polyvinyl acetoacetal resin | 4.25 parts |
| (S-LEC (R) KS-5, manufactured by Sekisui | |
| Chemical Co., Ltd.) | |
| Polyolefin wax | 0.2 parts |
| Modified silicone oil | 0.15 parts |
| (X-22-3939, manufactured by Shin-Etsu | |
| Chemical Co., Ltd.) | |
| Neoethanol | 4.2 parts |
| Toluene | 42.1 parts |
| Methyl ethyl ketone | 42.1 parts |

### <Coating Liquid M11 for Magenta Colorant Layer>

| | |
|---|---|
| As a sublimable dye, the compound represented | 3.0 parts |
| by General Formula (12) above | |
| As a sublimable dye, the compound represented | 3.0 parts |
| by General Formula (13) above | |
| Polyvinyl acetoacetal resin | 3.5 parts |
| (S-LEC (R) KS-5, manufactured by Sekisui | |
| Chemical Co., Ltd.) | |
| Polyolefin wax | 0.2 parts |
| Modified silicone oil | 0.15 parts |
| (X-22-3939, manufactured by Shin-Etsu | |
| Chemical Co., Ltd.) | |
| Neoethanol | 4.2 parts |
| Toluene | 42.1 parts |
| Methyl ethyl ketone | 42.1 parts |

### <Coating Liquid C11 for Cyan Colorant Layer>

| | |
|---|---|
| As a sublimable dye, the compound represented | 6.5 parts |
| by General Formula (17-1) above | |
| Polyvinyl acetoacetal resin | 4.55 parts |
| (S-LEC (R) KS-5, manufactured by Sekisui | |
| Chemical Co., Ltd.) | |
| Polyolefin wax | 0.2 parts |
| Modified silicone oil | 0.15 parts |
| (X-22-3939, manufactured by Shin-Etsu | |
| Chemical Co., Ltd.) | |
| Neoethanol | 4.2 parts |
| Toluene | 42.1 parts |
| Methyl ethyl ketone | 42.1 parts |

### Comparative Example 2

A sublimation thermal transfer sheet of Comparative Example 2 was obtained under entirely the same conditions as for Example 1 except that a coating liquid Y12 for a yellow colorant layer with the composition below was used as the coating liquid for a yellow colorant layer, that a coating liquid M12 for a magenta colorant layer with the composition below was used as the coating liquid for a magenta colorant layer, and that a coating liquid C12 for a cyan colorant layer with the composition below was used as the coating liquid for a cyan colorant layer.

### <Coating Liquid Y12 for Yellow Colorant Layer>

| | |
|---|---|
| As a high-ε sublimable dye, the compound represented | 2.0 parts |
| by General Formula (2-1) above | |
| As another sublimable dye, the compound represented | 5.0 parts |
| by General Formula (5) above | |
| Polyvinyl acetoacetal resin | 3.5 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### <Coating Liquid M12 for Magenta Colorant Layer>

| | |
|---|---|
| As a high-ε sublimable dye, the compound represented | 1.0 part |
| by General Formula (7-1) above | |
| As another sublimable dye, the compound represented | 3.5 parts |
| by General Formula (12) above | |
| As another sublimable dye, the compound represented | 2.5 parts |
| by General Formula (13) above | |
| Polyvinyl acetoacetal resin | 3.5 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### <Coating Liquid C12 for Cyan Colorant Layer>

| | |
|---|---|
| As a high-ε sublimable dye, the compound represented | 1.0 part |
| by General Formula (14-1) above | |
| As a high-ε sublimable dye, the compound represented | 2.0 parts |
| by General Formula (16) above | |
| As another sublimable dye, the compound represented | 2.31 parts |
| by General Formula (17-1) above | |
| Polyvinyl acetoacetal resin | 3.5 parts |
| (S-LEC (R) KS-5, manufactured by Sekisui Chemical | |
| Co., Ltd.) | |
| Polyolefin wax | 0.2 parts |
| Modified silicone oil | 0.15 parts |
| (X-22-3939, manufactured by Shin-Etsu Chemical | |
| Co., Ltd.) | |
| Neoethanol | 4.2 parts |
| Toluene | 42.1 parts |
| Methyl ethyl ketone | 42.1 parts |

### Production of Protective-Layer Thermal Transfer Sheet

A polyethylene terephthalate (PET) film having a thickness of 5 μm was used as a substrate. One surface of this substrate was coated with a coating liquid for a protective layer with the composition below with a wire coater bar so that the thickness after drying would be 1.0 μm. The product was dried to form a protective layer. Then, a coating liquid for an adhesive layer with the composition below was applied over the protective layer with a wire coater bar so that the thickness after drying would be 1.0 μm. The product was dried to form an adhesive layer. In addition, a coating liquid for a back face layer with the composition above was applied over the other surface of the substrate with a wire coater bar so that the thickness after drying would be 1.0 μm. The product was dried to form a back face layer. Accordingly, a protective-layer thermal transfer sheet in which the protective layer and the adhesive layer constituting a transfer layer were provided in this order on one surface of the substrate and in which the back face layer was provided on the other surface of the substrate was obtained.

### <Coating Liquid for Protective Layer>

| | |
|---|---|
| Acrylic resin | 19.5 parts |
| (Dianal (R) BR-83, manufactured by Mitsubishi | |
| Rayon Co., Ltd.) | |
| Polyester resin | 0.5 parts |
| (Vylon (R) 200, manufactured by Toyobo Co., | |
| Ltd.) | |
| Toluene | 40 parts |
| Methyl ethyl ketone | 40 parts |

### <Coating Liquid for Adhesive Layer>

| | |
|---|---|
| Polyester resin | 20 parts |
| (Vylon (R) 200, manufactured by Toyobo Co., Ltd.) | |
| Toluene | 40 parts |
| Methyl ethyl ketone | 40 parts |

### Preparation of Transfer Receiving Article

As transfer receiving articles, which were the counterparts of the sublimation thermal transfer sheets of Examples 1 to 7 and Comparative Examples 1 and 2 above, cards made of polyvinyl chloride (PVC cards, manufactured by Dai Nippon Printing Co., Ltd.) were provided.

### Production of Print

Using the sublimation thermal transfer sheets of Examples 1 to 7 and Comparative Examples 1 and 2 above, thermal transfer images having OD values (optical densities) of 1.6 and 1.8 were formed on the transfer receiving articles provided above under the following printing conditions.

### Printing Conditions

Thermal head: KEE-57-12GAN2-STA (manufactured by KYOCERA Corporation)

Average resistance value of heater elements: 3303 (Ω)

Printing resolution in the main scanning direction: 300 (dpi)

Printing resolution in the subscanning direction: 300 (dpi)

Printing voltage: changed at appropriate times depending on the sample

Line period: 1.5 (msec./line)

Print starting temperature: 35 (° C.)

Pulse duty ratio: 85(%)

Printing pattern: solid black (gray scale of 0/255)

Then, using each of the above protective-layer thermal transfer sheets, the transfer layer including the protective layer and the adhesive layer was transferred onto each thermal transfer image under the following transfer conditions to provide each print.

### Transfer Conditions for Transfer Layer

Thermal head: KEE-57-12GAN2-STA (manufactured by KYOCERA Corporation)

Average resistance value of heater elements: 3303 (Ω)

Printing resolution in the main scanning direction: 300 (dpi)

Printing resolution in the subscanning direction: 300 (dpi)

Printing voltage: 18.0 (V)

Line period: 1.5 (msec./line)

Print starting temperature: 35 (° C.)

Pulse duty ratio: 85(%)

Printing pattern: gray scale of 55/255, solid

### Evaluation of Suitability for Printing

The suitability of the produced print for printing was evaluated according to the following evaluation criteria.

### Evaluation Criteria

A: The thermal transfer image is not creased.

B: The thermal transfer image is creased to a degree that the creases did not matter practically.

NG: Large peelings of the transfer sheet are confirmed.

### Evaluation of Adhesiveness of Protective Layer

The produced print was immersed in ethanol for 24 hours, and the adhesiveness of the protective layer was evaluated by the tape adhesion test according to the following evaluation criteria. The tape adhesion test was performed by applying adhesive tape (Mending Tape MD-12C, manufactured by Nichiban Co., Ltd.) over the surface of the print, peeling off the adhesive tape at an angle of 180°, and inspecting the surface of the print after the tape was peeled off.

### Evaluation Criteria

OK: The transfer layer is completely in intimate contact, and no peeling, etc. occurs.

NG: Large flakes of the transfer layer are confirmed.

### Evaluation of Light Resistance

The print produced above having an OD value of 1.6 was irradiated using a xenon fade meter (CI4000, manufactured by Atlas) at 400 kJ (accumulated value at 420 nm) for 24 hours. CIRA soda lime was used as a filter. The OD values of the thermal transfer image before and after irradiation with light were measured using a spectrophotometer (i1, manufactured by X-Rite Inc.), the residual ratio of the density was calculated from the following equation, and the light resistance was evaluated according to the following evaluation criteria.

### Computational Equation For Residual Ratio of Density

The residual ratio of the density=(the OD value after irradiation)/(the OD value before irradiation)×100

### Evaluation Criteria

A: The residual ratio of the density is not less than 80%.

B: The residual ratio of the density is not less than 70% and less than 80%.

C: The residual ratio of the density is less than 70%.

### Results

Table 1 below summarizes the results of the evaluation of suitability for printing, the evaluation of adhesiveness of the protective layer, and the evaluation of light resistance described above.

TABLE 1

| | | | | OD value = 1.6 | | OD value = 1.8 | | |
|---|---|---|---|---|---|---|---|---|
| | | | | | Adhesive- | | Adhesive- | |
| | Proportion | | Proportion | | ness | | ness | |
| | of high-ϵ | Proportion | of | Suitability | of | Suitability | of | |
| | dye Y | of high-ϵ | indoaniline | for | protective | for | protective | Light |
| | and M | dye C | C | printing | layer | printing | layer | resistance |
| Example 1 | 1.11 | 1.10 | 0.73 | A | OK | A | OK | B |
| | | | | (16.0 V) | | (17.0 V) | | |
| Example 2 | 0.93 | 0.91 | 0.61 | A | OK | A | OK | B |
| | | | | (16.5 V) | | (17.5 V) | | |
| Example 3 | 0.98 | 0.86 | 0.86 | A | OK | A | OK | A |
| | | | | (16.5 V) | | (17.5 V) | | |
| Example 4 | 0.75 | 0.66 | 0.66 | A | OK | B | OK | A |
| | | | | (17.0 V) | | (18.0 V) | | |
| Example 5 | 0.78 | 0.99 | 0.66 | A | OK | B | OK | B |
| | | | | (17.0 V) | | (18.0 V) | | |
| Example 6 | 0.98 | 0.86 | 0.86 | A | OK | A | OK | A |
| | | | | (16.5 V) | | (17.5 V) | | |
| Example 7 | 0.73 | 0.87 | 0.37 | A | OK | B | OK | C |
| | | | | (17.0 V) | | (18.5 V) | | |
| Comparative | 0.00 | 0.00 | 0.00 | — | NG | — | NG | A |
| Example 1 | | | | Low | | Low | | |
| | | | | density | | density | | |
| Comparative | 0.43 | 0.86 | 0.38 | B | NG | NG | NG | C |
| Example 2 | | | | (18.5 V) | | (19.5 V) | | |

It is shown that the above results show that the sublimation thermal transfer sheets according to Examples 1 to 6 are superior in suitability for printing, the adhesiveness to the transfer layer, and light resistance. It is also shown that Example 7 is slightly inferior in light resistance because the amount of the indoaniline high-ε sublimable dye C contained in the cyan colorant layer was smaller than those in the other examples; concretely, because the mass ratio of the dye to the binder resin was less than 0.5.

### Explanation of The Numerals

10 Sublimation thermal transfer sheet
1 Substrate
2Y Yellow colorant layer
2M Magenta colorant layer
2C Cyan colorant layer
3 Primer layer
5 Back face layer

1. A sublimation thermal transfer sheet comprising:
a substrate, and
yellow, magenta, and cyan colorant layers provided on one surface of the substrate,
wherein the yellow colorant layer comprises at least a binder resin Y and a sublimable dye Y having a molar absorption coefficient of not less than 50000 and a molecular weight of not more than 650,
wherein the magenta colorant layer comprises at least a binder resin M and a sublimable dye M having a molar absorption coefficient of not less than 50000 and a molecular weight of not more than 650,
wherein the cyan colorant layer comprises at least a binder resin C and a sublimable dye C having a molar absorption coefficient of not less than 20000 and a molecular weight of not more than 650,
wherein an average of a mass ratio between the binder resin Y and the sublimable dye Y (the sublimable dye Y/the binder resin Y) and a mass ratio between the binder resin M and the sublimable dye M (the sublimable dye M/the binder resin M) is not less than 0.7, and
wherein a mass ratio between the binder resin C and the sublimable dye C (the sublimable dye C/the binder resin C) is not less than 0.5.

2. The sublimation thermal transfer sheet according to claim 1, the sublimation thermal transfer sheet comprising a sublimable dye represented by General Formula (14) below as the sublimable dye C at a mass ratio to the binder resin C of not less than 0.5: 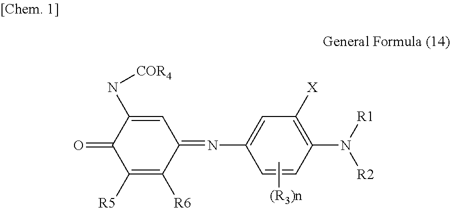
(in General Formula (14), R1 is a substituted or unsubstituted alkyl group, a cycloalkyl group, an aralkyl group, an aryl group, or represents an atom or atomic group forming a 5- or 6-membered ring together with X; R2 represents a substituted or unsubstituted alkyl group, a cycloalkyl group, an aralkyl group, or an aryl group; R1 and R2 may form a 5- or 6-membered ring optionally comprising an oxygen atom or a nitrogen atom; R3 represents a hydrogen atom, a halogen atom, a cyano group, an optionally substituted alkyl group, a cycloalkyl group, an alkoxy group, an aralkyl group, an aryl group, an acyl group, an acylamino group, a sulfonylamino group, a ureido group, a carbamoyl group, a sulfamoyl group, or an amino group; R4 represents a substituted or unsubstituted alkyl group, a substituted or unsubstituted cycloalkyl group, a substituted or unsubstituted aralkyl group, a substituted or unsubstituted aryl group, a substituted or unsubstituted alkoxy group, or a substituted or unsubstituted aryloxy group; R5 and R6 may be same or different and each represent a hydrogen atom, a halogen atom, a substituted or unsubstituted alkyl group, an alkoxy group, an acylamino group, a sulfonylamino group, or a ureido group; X is a hydrogen atom or represents an atom or atomic group forming a 5- or 6-membered ring together with R1; and n represents 1 or 2.)

3. A combination of a sublimation thermal transfer sheet and a transfer receiving article,
wherein the sublimation thermal transfer sheet comprises the sublimation thermal transfer sheet according to claim 1, and
wherein the transfer receiving article comprises a card material with a deflection of not more than 35 mm determined by a bending stiffness test defined by JIS X 6305-1.

4. A combination of a sublimation thermal transfer sheet and a transfer receiving article,
wherein the sublimation thermal transfer sheet comprises the sublimation thermal transfer sheet according to claim 2, and
wherein the transfer receiving article comprises a card material with a deflection of not more than 35 mm determined by a bending stiffness test defined by JIS X 6305-1.
